(19) United States
(12) Patent Application Publication
(10) Pub. No.: US 2010/0115775 A1
(43) Pub. Date: May 13, 2010

(54) EXTENSION CABLE AND PIPE PROCESSING DEVICE ADAPTED THERETO

(75) Inventor: Achim Scheider, Radolfzell (DE)

Correspondence Address: LOWE, HAUPTMAN, HAM & BERNER, LLP (ITW), 1700 DIAGONAL ROAD, SUITE 300, ALEXANDRIA, VA, 22314, US

(73) Assignee: ILLINOIS TOOL WORKS INC., Glenview, IL (US)

(21) Appl. No.: 12/532,047

(22) PCT Filed: Jan. 29, 2008
(86) PCT No.: PCT/EP2008/051057

§ 371 Date: Sep. 18, 2009

(30) Foreign Application Priority Data
Mar. 21, 2007 (DE) 10 2007 013 502.7

(51) Int. Cl. B23D 21/06; H01R 11/00

(52) U.S. Cl. 30/93; 30/92; 439/505

(57) ABSTRACT

A flexible electric power extension cable includes at least two conductors for electrical pipe processing equipment, a plug and a female cable connector part. The plug contains the at least two-conductors and is electrically connected to the front end of the electric power extension cable for receiving line power while geometrically fitting into a line-power electric outlet box. The female cable connector part contains the at least two conductors and is electrically connected to the rear end of the electric power extension cable. There is a mismatch between the geometry of the female cable connector part and that of the cable plug to preclude connection between the female cable connector part and the plug.

### RELATED APPLICATIONS

The present application is based on International Application Number PCT/EP2008/051057 filed Jan. 29, 2008, and claims priority from German Application Number 10 2007 013 502.7 filed Mar. 21, 2007, the disclosures of which are hereby incorporated by reference herein in their entirety.

### TECHNICAL FIELD

The present disclosure relates to a flexible electric power extension cable and a matched pipe processing equipment.

### BACKGROUND

In particular the present disclosure relates to pipe processing equipment in the form of a pipe cutting equipment such as is known from the German patent document DE 103 52 890 A1 (=US 2005/0097752 A1). Similar pipe equipment is known from the Swiss patent document 372202 and the German patent document DE 101 34 269 B4. Such equipment contains a clamp to affix a pipe segment to be cut off and a cutting system to cut the clamped pipe. The cutting system is supported at the clamp so as to be rotatable about a pipe longitudinal axis defined by said clamp. The cutting system contains a tool holder to hold a cutting tool, for instance a circular saw blade, further an electric motor to drive into rotation the said tool holder together with the tool affixed in it. The cutting system comprises a lever arm projecting for instance radially to said pipe's axis of rotation and designed to act as a grip or be fitted with a handlebar to rotate said lever arm about said pipe's axis of rotation. The electric motor may be received in the lever arm. Conventionally an electric power cable is connected to the cutting system to feed electric power to the electric motor. One end of said cable is situated in the cutting system, for instance in said lever arm, The other cable end away from the cutting system is plugged into a cable outlet socket, hereafter just outlet, by means of a plug matching the conventional outlets of the public power company and accordingly fits into such outlets to set up connection between the outside power line and the cable. Said power cable contains at least two conductors.

The cutting element may be a circular saw blade or a grinding cutting wheel.

The present disclosure also applies to pipe cutting systems disclosed in the German patent document DE 100 20 393 A1. Moreover it is applicable to pipe end processing means known for instance form the patent documents DE 197 26 498 A1, DE 100 14 578 A1 and DE 102 16 787 A1. Again it relates to combined; pipe cutting systems and pipe end processing means illustratively disclosed In the German patent document DE 196 03 361 A1. The latter machinery is used to cutting pipes and to bevel pipe ends in particular of thin-walled metal pipes.

Moreover the disclosure also relates to pipe cutting systems illustratively known from the patent documents U.S. Pat. No. 4,890,385 and U.S. Pat. No. 6,065,212. These contain a motor driving a rotary unit rotatably resting in a housing and supporting the pipe cutting tool. Said motor also displaces the cutting tool radially toward the pipe to be cut off. The housing and the rotary unit are fitted with a radial access aperture through which the pipe cutting system ca be radially displaced against a pipe to be cut.

In many countries the electrical power line outlet boxes are different. Consequently the pipe-processing equipment cable plugs designed to connect with said line outlets most of the time only fit into the power outlets of one country but not in any of the others. As a result the manufacturers of pipe processing means must manufacture a plurality of such different means each for a different country, and keep such in stock, and, when shipping them, take into account the particular power outlet of the particular country.

Pipe processing means such as pipe cutting systems and/or pipe-end processing devices are exposed to rough operational and environmental conditions. They are used in pipe processing shops and in rudimentary buildings. Consequently the flexible electrical cables of the pipe processing means are frequently damaged and require being exchanged. Such changing of cables entails opening the processing apparatus and connecting the new conductors of a new cable inside the pipe processing apparatus, further appropriately tension/stress-relieving said cable in said apparatus. For reasons of safety, a cable should not be exchanged by the pipe processing operator but instead by a qualified electrician. In other words, the pipe processing apparatus must be delivered to an electrical shop and then be picked up there later.

The pipe processing apparatus' cable sustains damage not only by being squeezed by persons standing on it or by metal objects dropping on it, but also by forces stretching it and possibly tearing it apart, or nearly so, due to somebody stepping on it or an object being dropped on it.

Another source of damage is the twisting of such a cable during use while not being entirely twist-relieved subsequently, but instead being stretched.

There is a need to improve the handling of pipe processing equipment.

### SUMMARY

This problem is solved by a flexible electric power extension cable for pipe processing equipment with a plug affixed to it and matching a cable connecting element of the extension cable.

Thus, a single design of the pipe processing equipment can be used in more than one countries. Merely different extension cables are required. If the extension cable should be or become defective, said equipment remains ready for operation. It need not be opened. Accordingly operational reliability is increased.

### BRIEF DESCRIPTION OF THE DRAWINGS

FIG. 1 schematically shows a flexible electrical power cable in combination with a matched pipe processing equipment,

FIG. 2 is a perspective of the extension cable of FIG. 1,

FIG. 3 is a perspective of a female cable connector part at the rear end of the extension cable,

FIG. 4 is a perspective of a male cable connector part matching the female cable connector part of FIG. 3 and jointly with it able to set up electrical connection between them,

FIG. 5 is the male cable connector part of FIG. 4 configured at the external end of a flexible power cable running into the housing of a lever arm of a cutting system of FIG. 6, and

FIG. 6 is a perspective of a pipe cutting system of which part is shown in FIG. 5.

### DETAILED DESCRIPTION

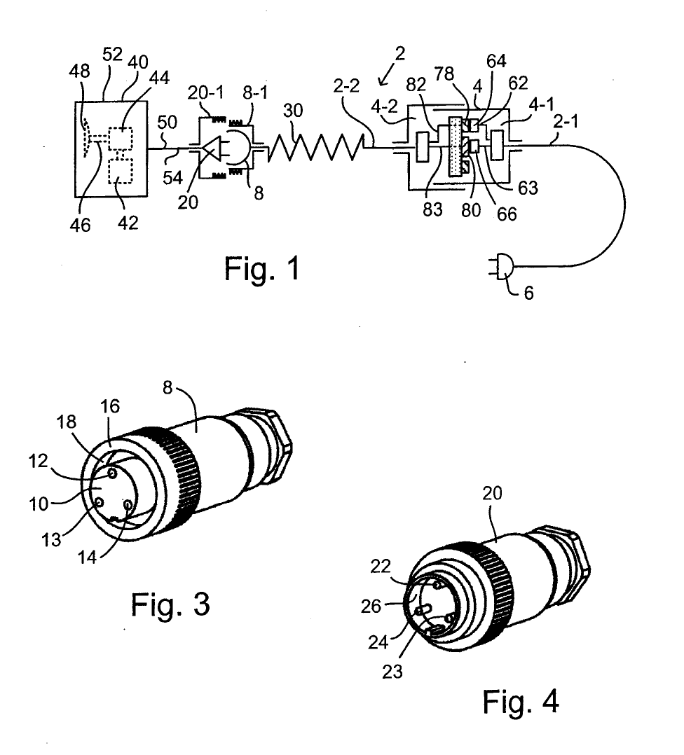

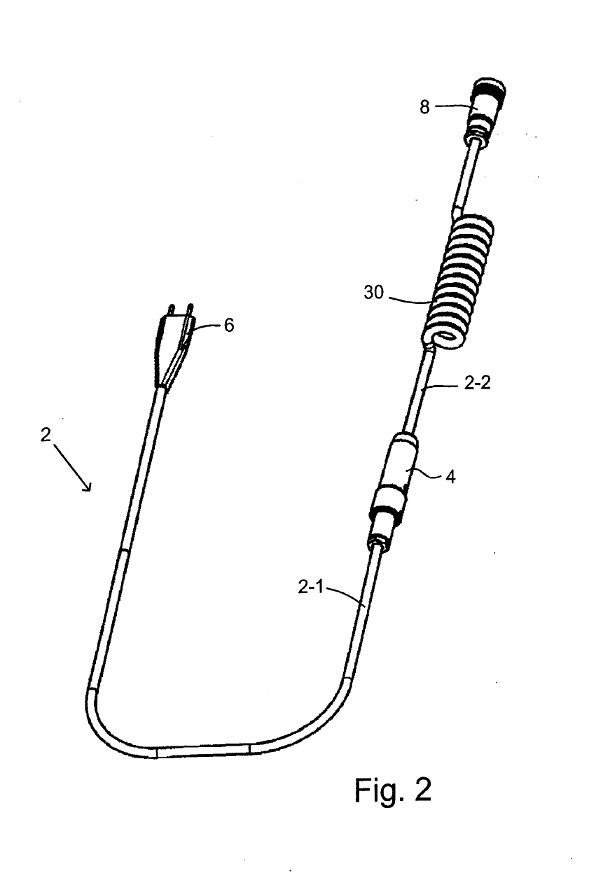

The flexible electric power extension cable 2 shown in FIGS. 1, 2 and 3 contains at least two conductors. The extension cable 2 comprises a front cable segment 2-1 and a rear cable segment 2-2. The two cable segments 2-1 and 2-2 are connected to each other by a rotary junction 4 allowing rotating said segments 2-1 and 2-2 about their longitudinal axis and relative to each other.

A plug 6 for at least two conductors is connected to the front end of the front cable segment 2-1. A female cable connector part 8 is connected to the rear end of the rear cable segment 2-2.

The cable plug 6 is a power-line accessing plug designed to be plugged into a power line's outlet to effect electrical connection.

The design of the female cable connector part 8 is different from the geometry of the power line outlets whereby the cable plug 6 does not fit into the female cable connector part 8 and therefore electrical connection between them is precluded. Electrical connection with the female cable connector part 8 is possible only with a matching cable plug or with a matching plug affixed to a pipe processing equipment.

FIG. 3 shows one of many possible female cable connector parts 8. It may comprise a central, electrically insulating connection dowel 10 containing at least two jacks 12, 13, and/or 14 of which the rearward-pointing ends are recessed in said dowel, said jacks therefore not protruding out of the dowel 10, the number of jacks corresponding to the number of conductors of the extension cable 2. An annular spacing 18 open toward the rear end face is subtended between the outer circumference of the connection dowel 10 and a housing ring 16 enclosing said dowel while radially spaced from it.

The female cable connector part 8 of FIG. 3 may be engaged by a plug mounted in fixed manner on the pipe processing equipment or by a second male cable connector part 20 shown in FIG. 4 to set up electrical connection, said male part 20 being fitted with contact pins 22, 23 and/or 24 aligned with the jacks 12, 13, and 14, and also being fitted with an electrically insulating muff 26 enclosing all engaging pins 22, 23 and 24 and fitting into the annular spacing 18 of the female cable connector part 8 of FIG. 3. In this manner the female cable connector part 8 can be made to engage, i.e. to make electrical contact with, the male cable connector part 20 of FIG. 4 or a stationary plug designed in the manner of the male cable connector part 20 to set up electrical connection.

The number of jacks 12, 13, 14 and the number of the matching pins 22, 23, 24 is at least two, though it may be another number, for instance 3, 5, 6 or more. Such a number may be higher than required electrically, for instance when the said female and male parts or other connection elements might be more economical than for a lower number.

The rear cable segment 2-2 is constituted over at least part of its length by a coil 30, so that this portion of the segment 2-2 resembles a helical spring and may expand elastically in the longitudinal direction of said rear segment.

The pipe processing equipment 40 is schematically shown in FIG. 1. It may be a pipe cutting system or a pipe-end processing apparatus or a combined pipe cutting system and pipe-end processing apparatus. It includes an electric motor 42 which directly or by means of a gear unit 44 drives into rotation a tool support 46 and a tool 48 affixed to it. The pipe processing equipment 40 may be fitted with a flexible electric cable 50 to feed power to the said motor 42, this cable being connectable within a housing 52 of said pipe processing equipment to the electric motor 42 by means of an omitted switch. This connection may be implemented either directly or through a storage battery. A male cable connector part 20 is connected to the external end of the external cable portion 54 and matches the female cable connector part 8 of the extension cable 2 to allow mutual electrical connection. The external male cable connector part may be said part 20 discussed in relation to FIG. 4.

Instead of an external male cable connector part 20 matching the female cable connector part 8 of the extension cable 2, a fixed electric plug matched to the female cable connector part 8 of said cable might be mounted on the pipe affixation device, for instance on the housing 52, so as to engage these parts to implement electrical connection.

To prevent the external male cable connector part 20 of FIGS. 1 through 4 from lying on the ground during operation of the pipe processing equipment, in which case it might be damaged, the length of the external cable portion 54 from the housing 52 to the external male cable connector part 20 preferably shall be between 5 cm and at most 60 cm, the minimum length preferably being 10 cm and the maximum length preferably being 40 or 30 Cm.

In order to prevent accidentally separating from each other the female cable connector part 8 and the external male cable connector part 20, or in lieu of latter a stationary plug on the pipe processing equipment 40, they are preferably fitted with a locking element 8-1 respectively 20-1, for instance mutually meshing threads as indicated schematically in FIG. 1, or with a locking lever and a locking protrusion that may be mechanically interlocked and each requiring separation from one another before the female cable connector part 8 can be separated from the external male cable connector part 20 or from a matched stationary plug on the pipe processing equipment 40. As regards a preferred embodiment mode, the locking elements 8-1 and 20-1 are designed to constitute a bayonet lock.

As schematically shown in FIG. 1, the rotary junction 4 contains mutually locking elements 4-1 and 4-2 rotatable about the cable longitudinal axis. The locking element 4-1 contains the rear end conductors of the front cable segment 2-1, two of said conductors, of which the elements 62 and 63 are shown, making contact with their terminals 64 respectively 66 that in turn slide on contacts 78 respectively 80 of the other locking element 4-2. These further contacts 78 and 80 are connected at the front end of the rear cable segment 2-2 to the conductors 82 respectively 83 (or more) of the rear cable segment 2-2.

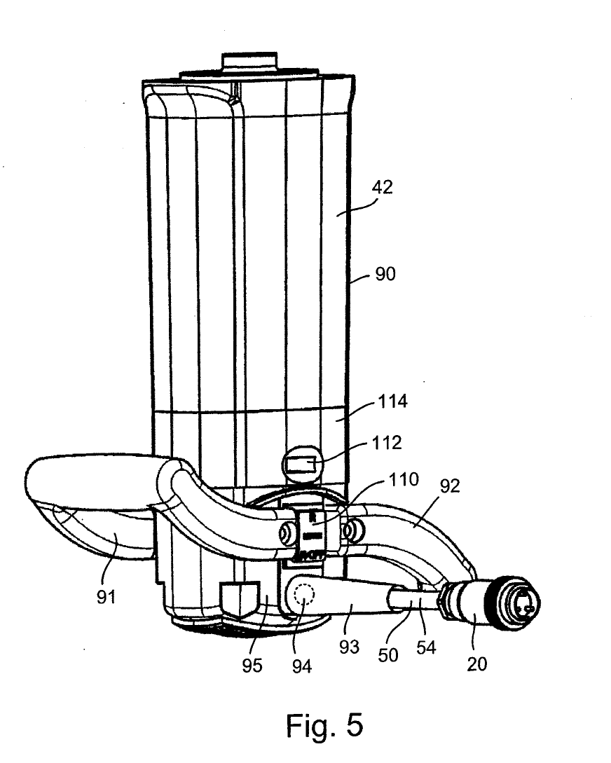

FIG. 5 shows a lever arm 90 for the pipe processing equipment 40 of FIG. 1. This lever arm 90 illustratively may contain the electric motor 42 and be fitted with one or two handlebars 91 and/or 92. The outer cable portion 54 together with the external male cable connector part 20 at the external end of the lever arm runs through a cable sheath 93 and a housing aperture 94 into a housing element 95 of said lever arm.

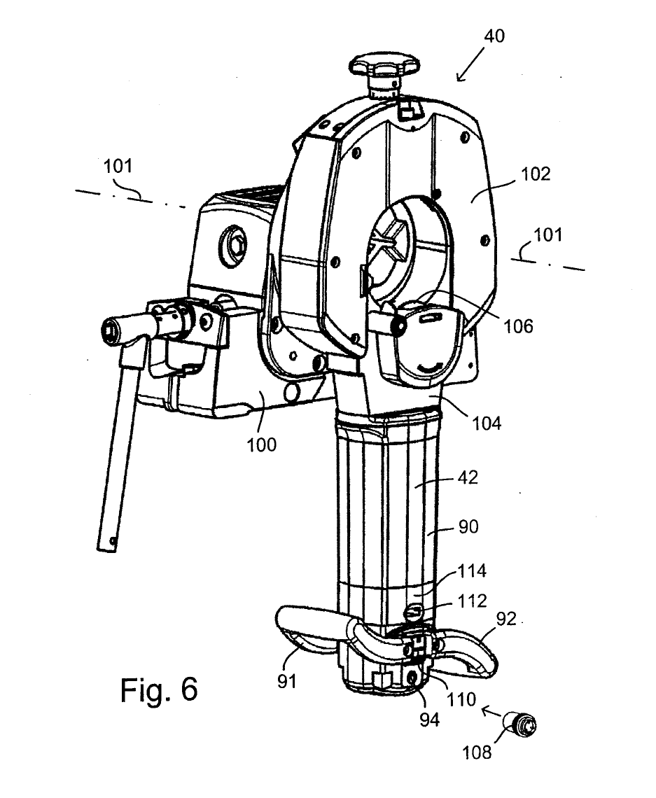

FIG. 6 illustrates a detailed embodiment mode of the pipe processing equipment 40. Illustratively it contains a pipe clamp 100 for instance in the form of a vise to clamp a pipe being processed and defines a longitudinal axis of such a pipe. A rotary unit 102 rests on said clamp 100 and is rotatable about the longitudinal pipe axis 101. A slider 104 is configured at the clamp 100 and rotates about the said longitudinal pipe axis. The slider 104 supports an omitted, rotatable tool holder for a pipe processing tool 106, for instance a cutting tool such as a circular saw blade or a grinding cutting disk.

A pipe-end processing apparatus also might be used in lieu of a pipe cutting tool 106.

The lever arm 90 runs transversely to the longitudinal pipe axis 101, for instance radially to it.

FIG. 6 shows the housing access aperture 94 for the hookup cable 50 of the pipe processing equipment 40. Instead of a power cable 50, an electric plug 108 might be mounted in stationary manner at the pipe processing equipment 40, in particular at its lever arm 90, said plug being designed in a manner that it cannot enter the power line electric outlets but instead is matched to the cable female cable connector part 8 of the power extension cable 2 to allow connecting it with the female cable connector part 8 to set up electrical connection. In this instance said housing aperture 94 is not needed. Illustratively the plug 108 may be mounted at the site previously assumed by the said aperture 94.

An ON/OFF switch 110 turning the motor 42 on/off may be mounted on the lever arm 90. Also an angular-speed regulator 112 may be fitted to the lever arm 90 to adjust motor speed. Again said lever arm 90 may be fitted with an electronics 114 to keep constant the motor speed set at the regulator 112 regardless of the load on the tool 106.

Instead of one or more handlebars 91, 92 being affixed to the lever arm 90, said lever arm per se may be designed as a grip.

1. A flexible electric power extension cable, comprising:
at least two conductors for electrical pipe processing equipment;
a plug that contains said at least two-conductors and is electrically connected to the front end of the electric power extension cable for receiving line power while geometrically fitting into a line-power electric outlet box; and
a female cable connector part that contains said at least two conductors and is electrically connected to the rear end of the electric power extension cable;
wherein there is a mismatch between the geometry of the female cable connector part and that of the cable plug to preclude connection between them

2. The electric power extension cable as claimed in claim 1, wherein
the electric power extension cable comprises a front cable segment and a rear cable segment;
the two cable segments are connected by a rotary junction to each other in a way that said cable segments are mutually rotatable;
the cable plug is connected to the front end of the front cable segment and is a power-line plug fitting into a power-line outlet; and
the female cable connector part is electrically connected to the rear end of the of the rear cable segment.

3. The electric power extension cable as claimed in claim 2, further comprising
a coil of a plurality of turns in the rear cable segment at least over a part of a length of the rear cable segment so as to be elastically expansible in the longitudinal direction of the cable.

4. The electric power extension cable as claimed in claim 1, wherein
the female cable connector part comprises a central, insulating locking dowel having at least two electrically conducting jacks which do not protrude rearward from the dowel in a manner that the plug can be engaged therewith,
the plug comprises
electrically conducting plug pins matching said jacks, and
an electrically insulating locking muff running axially beyond the ends of the plug pins, matched in shape to that of the dowel, and being slippable onto said dowel.

5. The electric power extension cable as claimed in claim 1, wherein the female cable connector part comprises a mechanical lock to lock said female cable connector part to a corresponding pluggable male cable connector part.

6. Pipe processing equipment in the form of a pipe-end processing apparatus comprising:
an electric motor for driving a tool support; and
a flexible electric power cable for feeding power to the motor, said cable comprising:
at least two conductors in an external cable portion that protrudes from a housing of said processing equipment, and
an external male cable connector part that contains said at least two conductors and is connected to the external end of said external cable position;
wherein the external male cable connector part matches the geometry of the female cable connector part of the extension cable of claim 1 whereby the external male cable connector part of the equipment is engageable with the female cable connector part of the extension cable to effect electrical connection between said parts.

7. Pipe processing equipment as claimed in claim 6, wherein the length of the external cable portion from the housing to the external female cable connector part is at least 5 cm and at most 60 cm.

8. Pipe processing equipment in the form of a pipe cutting system or a pipe-end processing apparatus, comprising:
an electric motor for rotating a tool support; and
a plug that contains at least two conductors and is affixed in stationary manner to the pipe processing equipment for feeding electric power to the motor;
wherein the plug matches the geometry of the female cable connector part of the extension cable defined in claim 1 whereby said plug of the equipment is engageable with said female cable connector part of the extension cable to electrically connect said plug of the equipment and said female cable connector part of the extension cable to each other.

9. Pipe processing equipment as claimed in claim 6, further comprising:
a pipe clamp for affixing a pipe to be processed and said processing equipment to process the clamped pipe;
wherein the processing equipment is affixed to the pipe clamp in a manner to be rotatable about a longitudinal pipe axis defined by said pipe clamp.

10. Pipe processing equipment as claimed in claim 9, wherein the processing equipment further comprises at least one handle to manually rotate the processing equipment about the longitudinal pipe axis defined by the pipe clamp.

11. Pipe processing equipment as claimed in claim 6, being a manually operated equipment comprising at least one handle and rotatable by means of said handle about a pipe being processed.

12. Pipe processing equipment of claim 8, further comprising:
a pipe clamp for affixing a pipe to be processed and said processing equipment to process the clamped pipe;
wherein the Processing equipment is affixed to the pipe clamp in a manner to be rotatable about a longitudinal pipe axis defined by said pipe clamp.
